(19) United States
(12) Patent Application Publication
(10) Pub. No.: US 2004/0040420 A1
(43) Pub. Date: Mar. 4, 2004

(54) Spanner

(76) Inventor: Andreas Dierolf, Untertuerkheim (DE)

Correspondence Address: QUARLES & BRADY LLP, 411 E. WISCONSIN AVENUE, SUITE 2040, MILWAUKEE, WI, 53202-4497, US

(21) Appl. No.: 10/465,290

(22) Filed: Jun. 19, 2003

(30) Foreign Application Priority Data
Jun. 21, 2002 (DE) 202 09 895.8

(51) Int. Cl. B25B 13/46

(52) U.S. Cl. 81/60

(57) ABSTRACT

The invention relates to a spanner or wrench with a shank on whose one end is located a head. In said head is provided a drive for a tool. The drive recess receives the shank of a screwdriver bit and is provided with a closed base.

The invention relates to a spanner or wrench, e.g. a ratchet spanner or wrench. Spanners of this type have at the end of a shank a driving head in which is located a freewheel mechanism, which permits driving in only one rotation direction. The drive for a tool, normally referred to as a clamping piece or nut, is a projecting, cross-sectionally square journal.

In the case of simpler constructions without a reversing device for the rotation direction, said journal can be engaged through the head, so that it in each case projects from the other side. This economizes on the reversing device between the two rotation directions.

Spanners are also known with such a ratchet intended for direct application to the screw head. These spanners have a relatively shallow construction and are obtainable for specific widths over flats.

The problem of the invention is to provide a spanner, which can be assembled from standard parts, particularly for the ratchet mechanism, and with which it is possible to use commercially available screwdriver bits.

For solving this problem the invention proposes a spanner having the features according to claim 1. Further developments of the invention form the subject matter of subclaims.

Whereas a conventional ratchet spanner has a square projection, the spanner proposed by the present invention has a recess, which is matched to the shank of a commercially available screwdriver bit. This makes it possible to use screwdriver bits of this type with spanners, particularly ratchet spanners.

According to a further development of the invention the drive recess has a base. Commercial screwdriver bits are in part constructed in such a way that the shank, which is used for fixing purposes, has no collar, which could be used for limiting the sliding in movement. According to the invention the drive recess is consequently provided with a base, which can be used for limiting the sliding in movement of the shank of the screwdriver bit.

In the case of known ratchet spanners, with the exception of the journal which can be passed through, the drive structure is part of the spanner head. The invention now proposes that the drive recess be constructed in an insert manufacturable as a separate component and which can optionally be combined with a conventional spanner during spanner manufacture.

According to the invention the insert can be fixed in secured manner in the spanner head. For securing purposes can e.g. be provided a circlip, a retaining ring or a similar mechanism and this makes it possible to replace the insert.

For the secure fixing of the screwdriver bit, the drive recess can be constructed in such a way that it has a substantially radially movable thrust or pressure member for fixing the shank of the screwdriver bit. The pressure member can in particular be subject to the action of a spring in order to facilitate or permit the insertion and removal of the screwdriver bit.

The pressure member can in particular be a ball.

Further features, details and advantages of the invention can be gathered from the following description of a preferred embodiment of the invention, the claims, whose wording is by reference made into part of the content of the description, as well as the attached drawings, wherein show:

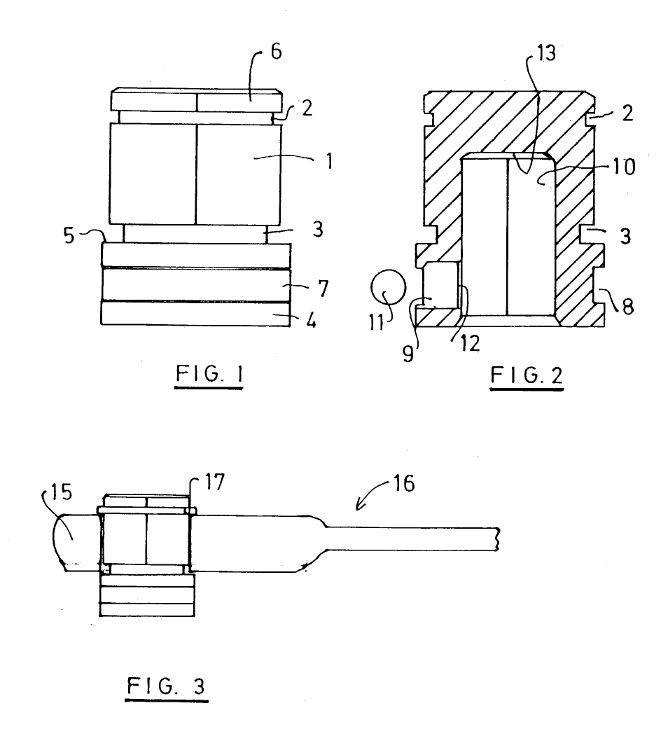

FIG. 1 The side view of an insert for a spanner according to the invention.

FIG. 2 An axial section through the insert of FIG. 1.

FIG. 3 Diagrammatically the arrangement of such an insert in the head of a spanner.

FIG. 1 is a side view of an insert proposed by the invention as an insert for a ratchet spanner or wrench. The insert contains a central, polygonal shank part 1, e.g. in the form of a hexagon. On both sides the polygonal shank part 1 is bounded by a circumferential groove 2, 3. At the lower end of the shank part 1 in FIG. 3 is formed a circular cylindrical edge 4, which forms a shoulder 5 in transition to the shank part 1. At the opposite end and beyond the groove 2 there is an extension of the polygonal shank part 1 in the form of a polygonal edge part 6. The cross-section of the insert within the area formed by the grooves 2, 3 is also circular, as is the cross-section through the front edge 4. In the circumference of the front edge 4 is provided a groove, which is covered by a spring washer 7. The outside of the spring washer 7 roughly corresponds to the outside of the remaining part of said front edge 4.

FIG. 4 shows on the same scale a longitudinal section through the insert of FIG. 1. From the aforementioned groove 8 in the front area of the insert a radial, circular opening 9 leads into the interior of the insert, in which his formed a hexagonal recess 10. In the opening 9 is placed a ball 11, which is moved inwards by the spring washer 7. A raised edge 12 prevents the ball 11 from falling into the inner recess 10.

The inner recess 10 of the insert is concentric to the outside of the insert and has a constant, hexagonal cross-section. The recess 10 has a base 13. Into the recess 10 can be slid the shank of a screwdriver bit until its end rests on the base 13. The ball 11, which is moved inwards by the spring washer 7, locks the shank of the screwdriver bit in such a way that its dropping out is prevented. It is naturally also possible to extract the screwdriver bit again counter to the action of the spring washer 7.

The insert is inserted in a corresponding recess in the head of a spanner 16. In the head 15 is provided a ratchet, i.e. a freewheel mechanism, which has such a hexagonal, through opening, in which is inserted the polygonal shank part 1 of the insert. In the axial direction it is fixed on the one hand by the engagement of the shoulder 5 on the lower side of the head 15 in FIG. 3 and on the other hand by a retaining ring 17, which engages in the groove 2. As can be seen in FIG. 1, the cylindrical edge 4 of the insert remains completely outside the head 15 of the spanner 16. Thus, FIG. 3 diagrammatically shows a ratchet spanner in which can be inserted and used a commercially available screwdriver bit.

In the embodiment shown the insert is inserted in a ratchet spanner. It could also be used with a spanner without a reversible ratchet.

1. Spanner having a shank, a head located at the end of the shank, a drive for a tool located in the head and which is constructed as a drive recess for the shank of a screwdriver bit.

2. Spanner according to claim 1, wherein the drive recess has a base.

3. Spanner according to claim 1, wherein the drive recess is formed in an insert.

4. Spanner according to claim 3, wherein the insert is fixed in secured manner in the spanner head.

5. Spanner according to claim 1, wherein the drive recess has a pressure member for fixing the bit.

6. Spanner according to claim 5, wherein a spring acts on the pressure member.

7. Spanner according to claim 5, wherein the pressure member is a ball.

8. Insert for a spanner or wrench, the insert having a drive recess for the shank of a screwdriver bit
